(19) United States
(12) Patent Application Publication
(10) Pub. No.: US 2012/0105677 A1
(43) Pub. Date: May 3, 2012

(54) METHOD AND APPARATUS FOR PROCESSING LOCATION INFORMATION-BASED IMAGE DATA

(75) Inventors: Woo-Sung KANG, Hwaseong-si (KR); Mu-Sik KWON, Seoul (KR); Seong-Taek HWANG, Pyeongtaek-si (KR)

(73) Assignee: Samsung Electronics Co., Ltd., Suwon-si (KR)

(21) Appl. No.: 13/288,550

(22) Filed: Nov. 3, 2011

(30) Foreign Application Priority Data
Nov. 3, 2010 (KR) 10-2010-0108578

(51) Int. Cl. H04N 5/76

(52) U.S. Cl. 348/231.3; 348/E05.024

(57) ABSTRACT

An apparatus for processing image data includes a camera for detecting image information received through an image sensor, a location information checker for checking location information, a memory for storing the image information and shooting location information at an acquisition time of the image information, a location information converter for converting the shooting location information based on display location information at a time the image information is to be displayed, and a controller for controlling output of image information corresponding to the display location information.

### PRIORITY

This application claims priority under 35 U.S.C. §119(a) to a Korean Patent Application filed in the Korean Intellectual Property Office on Nov. 3, 2010 and assigned Serial No. 10-2010-0108578, the contents of which are incorporated herein by reference.

### BACKGROUND OF THE INVENTION

1. Field of the Invention

The present invention relates generally to a method and apparatus for processing image data, and more particularly, to a method and apparatus for processing image data based on location information including information related to a shooting direction, shooting angle, angular speed and acceleration of a terminal.

2. Description of the Related Art

Objects distributed in three-dimensional (3D) space have generally been represented in two-dimensional (2D) image data by cameras with an image sensor. The recent development of 3D image processing technology has made it possible to represent or render, on a mobile terminal, objects distributed in the 3D space in 3D image data using stereoscopic images. However, to implement 3D image data in this manner, a camera lens is additionally required, making it difficult to implement lightweight, compact mobile terminals.

Taking this into consideration, a method of providing a similar effect to that of 3D images with use of 2D images has been proposed. Specifically, 2D images are acquired or captured at various locations, and the images are stored with location information including information about a shooting direction, shooting angle, angular speed and acceleration of the acquired images. The images are dynamically provided or displayed in response to a motion of a mobile terminal of a user who checks or views the images.

However, it is likely that information about a shooting direction, shooting angle, angular speed and acceleration at a time when the images were acquired is not matched to the same information at a time when the user checks the images. As a result, location information at the time the images were acquired is not matched to location information at the time the user checks the images, making it impossible to smoothly display the images.

### SUMMARY OF THE INVENTION

An aspect of the present invention is to provide a method and apparatus capable of smoothly displaying images by matching location information at a time the images were acquired, to location information at a time a user checks the images.

In accordance with an aspect of the present invention, there is provided a method for processing image data, including checking image information and shooting location information indicating location information at an acquisition time of the image information, storing the image information and the shooting location information, checking display location information indicating location information of a terminal that will display the image information, converting the shooting location information into the display location information by matching the shooting location information to the display location information, and outputting image information corresponding to the display location information.

In accordance with another aspect of the present invention, there is provided an apparatus for processing image data, including a camera for detecting image information received through an image sensor; a location information checker for checking location information, a memory for storing the image information and shooting location information at an acquisition time of the image information, a location information converter for converting the shooting location information based on display location information at a time the image information is to be displayed, and a controller for controlling output of image information corresponding to the display location information.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a mobile terminal with an image data processing device according to an embodiment of the present invention;

FIGS. 2A to 2C illustrate location coordinates converted by an image data processing device according to an embodiment of the present invention;

FIG. 3A illustrates a central shooting mode for capturing images centering on a user;

FIG. 3B illustrates a surrounding shooting mode for capturing images centering on a subject;

FIG. 4 illustrates location information corrected by an image data processing device according to an embodiment of the present invention;

FIG. 5 illustrates image information interpolated by an image data processing device according to an embodiment of the present invention;

FIG. 6 illustrates a process of capturing images based on location information in an image data processing method according to an embodiment of the present invention;

FIG. 7 illustrates a process of checking photos taken based on location information in an image data processing method according to an embodiment of the present invention; and

FIG. 8 illustrates a detailed process of step 706 of outputting image information corresponding to the display location information in FIG. 7.

Throughout the drawings, the same drawing reference numerals will be understood to refer to the same elements, features and structures.

### DETAILED DESCRIPTION OF EMBODIMENTS OF THE INVENTION

Embodiments of the present invention will now be described in detail with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for the sake of clarity and conciseness.

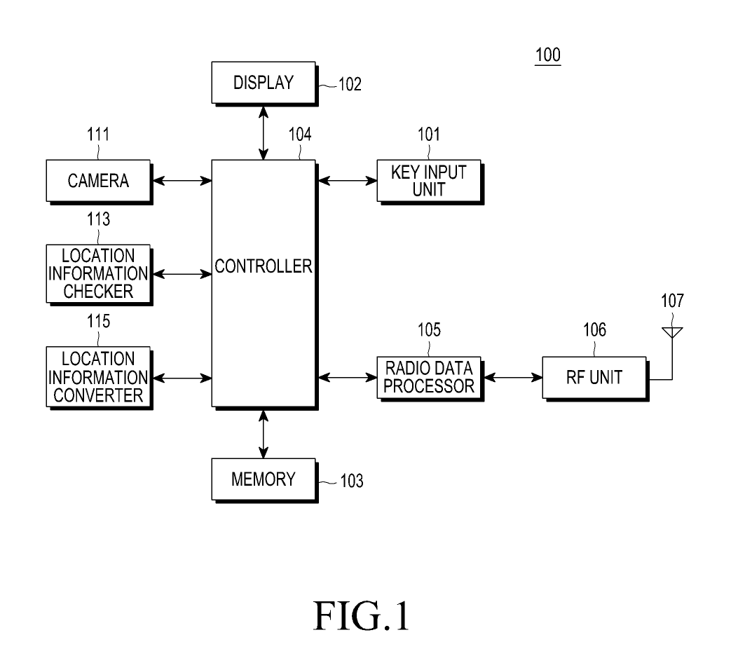

FIG. 1 illustrates a mobile terminal with an image data processing device according to the present invention. A mobile terminal will be given as an example of a hardware-based device to which the present invention may be applied. Although a mobile terminal with the disclosed image data processing device is given as an example in the present invention, it will be understood by those of ordinary skill in the art that the present invention is not limited thereto, and the disclosed image data processing device may be applied to various image processing devices, such as a digital camera.

Referring to FIG. 1, the mobile terminal 100 with the disclosed image data processing device includes a key input unit 101, a display 102, a memory 103, a controller 104, a radio data processor 105, a Radio Frequency (RF) unit 106, and an antenna 107. In particular, the mobile terminal 100 further includes a camera 111, a location information checker 113, and a location information converter 115.

The key input unit 101 is for receiving phone numbers or texts from a user, includes keys for inputting numeric and text information and function keys for setting various functions, and outputs its input signals to the controller 104. The key input unit 101 may include key buttons, a keypad, or a touch screen, which are generally mounted on a mobile terminal.

The display 102 may include a display unit such as a Liquid Crystal Display (LCD). Under control of the controller 104, the display 102 displays image information generated by the camera 111, image information stored in the memory 103, and a user interface run by the controller 104, or information and images generated by application programs, including messages regarding various operation states of the mobile terminal.

The memory 103 stores application programs for basic functions of the mobile terminal, and application programs selectively installed by the user. In particular, the memory 103 stores image information generated by the camera 111, and also receives shooting location information at a time the image information is acquired, from the location information checker 113, and stores the shooting location information together with the image information.

The controller 104 controls the overall operation of the mobile terminal. In other words, the controller 104 performs the processing corresponding to key inputs, numbers, or menu selection signals, which are received from the key input unit 101, stores application programs for basic functions of the mobile terminal in the memory 103, and runs requested application programs. In addition, the controller 104 stores application programs selectively installed by the user, in the memory 103, and reads and runs an application program in response to an execution request.

The controller 104 receives a camera operation start signal (i.e., a signal for activating an operation of the camera) or a shooting request signal (i.e., a request signal for capturing images) from the key input unit 101, and controls an operation of the camera 111 in response thereto. The controller 104 outputs or displays, on the display 102, image output signals necessary for various operations, including image information generated by camera shooting, and stores the image information generated by camera shooting in the memory 103.

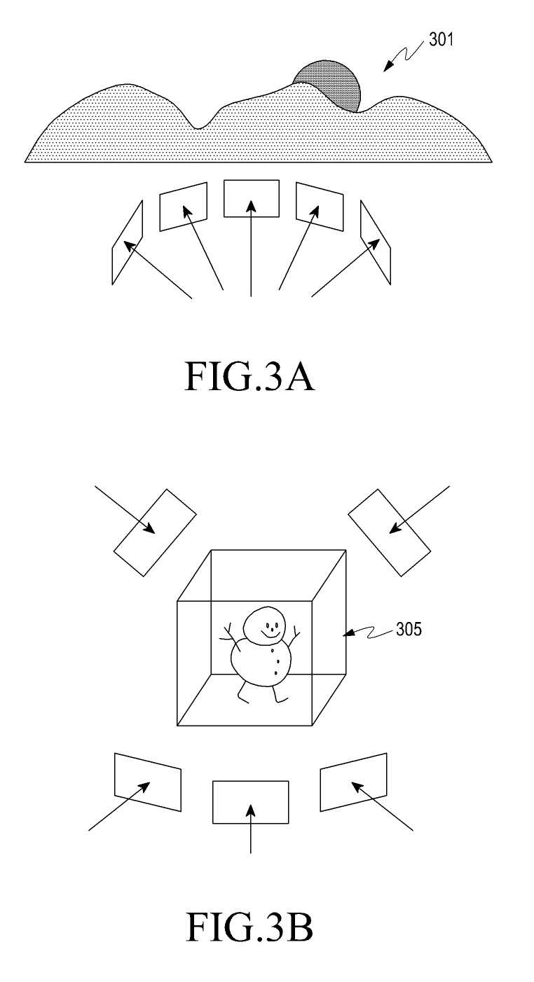

Upon receiving a camera operation start signal, the controller 104 may provide a user interface on which a camera's shooting mode is selected. For example, the controller 104 may provide a menu in which the user selects any one of a video mode and a photo mode of the camera. When the controller 104 signals to the user to select or determine whether the user will activate a location information-based photo taking mode, or to take photos with a location information-based photo taking function, the controller 104 may provide an interface on which the user may select any one of a central shooting mode for taking photos of an object 301 centering on the user as shown in FIG. 3A, and a surrounding shooting mode for taking photos of an object 305 centering on the object as shown in FIG. 3B. The controller 104 may store the mode selected by the user in the memory 103 together with the image information.

The RF unit 106 modulates user's voices, texts, and control data into radio signals, and transmits the radio signals to a base station (not shown) of the mobile communication network via the antenna 107. The RF unit 106 receives radio signals from the base station via the antenna 107, and demodulates the received radio signals into voices, texts and control data. Under control of the controller 104, the radio data processor 105 decodes voice data received from the RF unit 106, and outputs the decoded voice data in audible sound through a speaker. The radio data processor 105 converts user's voice signals picked up by a microphone into voice data, and outputs the voice data to the RF unit 106. The radio data processor 105 provides the texts and control data received from the RF unit 106 to the controller 104.

The camera 111 includes an image sensor for detecting color information of a target object and converting the color information into an electrical image signal, such as a Charge Coupled Device (CCD) and Complementary Metal-Oxide Semiconductor (CMOS), and an Image Signal Processor (ISP) for generating image information by processing information output from the image sensor. For the processing such as Live View, the camera 111 detects image information at time intervals, such as every 1/30 seconds, and provides the image information to the display 102.

The location information checker 113 includes a sensor for detecting information about at least one of a shooting direction, shooting angle, angular speed and acceleration of the camera 111. Operation of the location information checker 113 is controlled by the controller 104. For example, the location information checker 113 may be enabled when a request signal for capturing images is sent to the camera 111, or at time intervals when an application program is run for checking images captured by the camera 111 at various angles according to the motion of the mobile terminal. The location information checked by the location information checker 113 is provided to the controller 104, which stores the location information in the memory 103 as shooting reference location information and shooting location information, or uses the location information when displaying the image information based on display reference location information or display location information using a location information-based photo viewer function.

If the time or location at which the images were captured is different from the time or location at which the user checks the images, the location information at the time the images were captured is different from the location information at the time the user checks the images, making it difficult for the captured images to be smoothly provided to the user who checks the images. Therefore, once a location information-based photo viewer function is run, the controller 104 signals the user to select an image group to be displayed, and enables the location information converter 115. Accordingly, the location information converter 115 receives initial location information (i.e., display reference location information) from the location information checker 113, and checks the shooting reference location information of the image group from the memory 103. The location information converter 115 corrects the shooting reference location information and the entire shooting location information of the image group, based on the display reference location information.

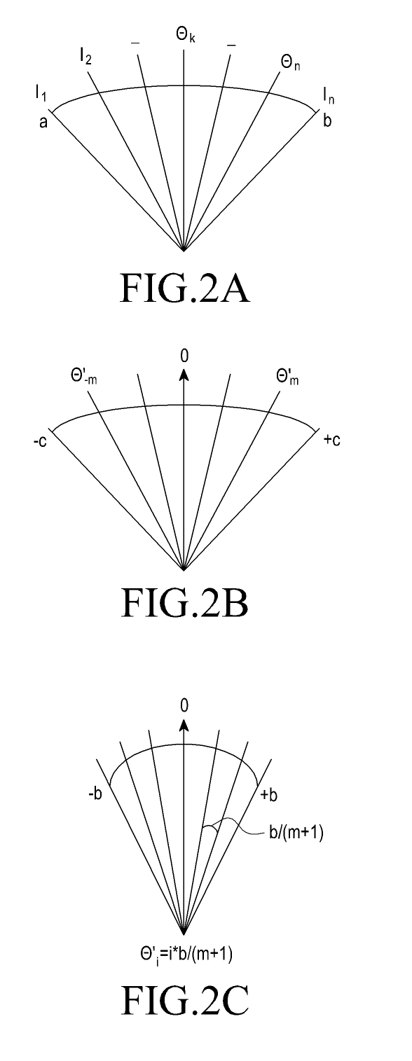

Specifically, the location information converter 115 detects a location coordinate set by checking location coordinates at a time at least one image included in the image group was captured. The location information converter 115 normalizes the detected location coordinate set. For example, at least one image included in the image group of FIG. 2A may be indicated as I₁, I₂, . . . Iₙ, and the image group may be indicated as (I₁, I₂, . . . Iₙ). The location coordinate set of the image group may be defined as Equation (1) below.

Θ=(Θ₁,Θ₂, . . . ,Θₙ) (1)

The normalized location coordinate set can be defined as Equation (2) below.

(Θ₁′,Θ₂′, . . . ,Θₙ′)=(Θ₁−Θₖ,Θ₂−Θₖ,Θ₃−Θₖ, . . . ,Θₙ−Θₖ) (2)

where Θₖ represents a median value in the location coordinate set.

The location information converter 115 calculates reference values to represent resolutions in the left and right directions centered on the median value in the normalized location coordinate set, in accordance with Equation (3) below.

(Θ₁′,Θ₂′, . . . ,Θₙ′)=Θ₋ₘ−Θ₋₍ₘ₋₁₎′, . . . ,Θ₀′,Θ₁′, . . . ,Θₘ′) (3)

Through this computation by the location information converter 115, the location coordinates (a, b) shown in FIG. 2A are converted into location coordinates (−c, c) shown in FIG. 2B. The location information converter 115 converts the converted location coordinates (−c, c) into coordinates having a symmetrical structure centered on the middle location, and stores the converted coordinates. In this case, a difference in average location between adjacent images is c/(m+1).

Once a location information-based photo viewer function is run, the controller 104 displays an image existing in the middle location, among the coordinate-converted images.

The location the user checks the images using the location information-based photo viewer function may be different from the location the images were captured. Accordingly, the controller 104 may provide a menu in which the user may set an interval of the location when the user checks the images. If the user sets an interval of the location when the user checks the images, the location information converter 115 may convert the converted location coordinates (−c, c) into coordinates (−b, b) and reset the difference in location between adjacent images to b/(n+1) as shown in FIG. 2C.

When the user checks the images captured by the central shooting mode in the surrounding shooting mode, or when the user checks the images captured by the surrounding shooting mode in the central shooting mode, errors may occur in checking the images captured based on location information. Therefore, if the user selects an image group to be displayed, the controller 104 may provide the user with information about the mode in which the image group was captured, i.e., the central shooting mode or the surrounding shooting mode.

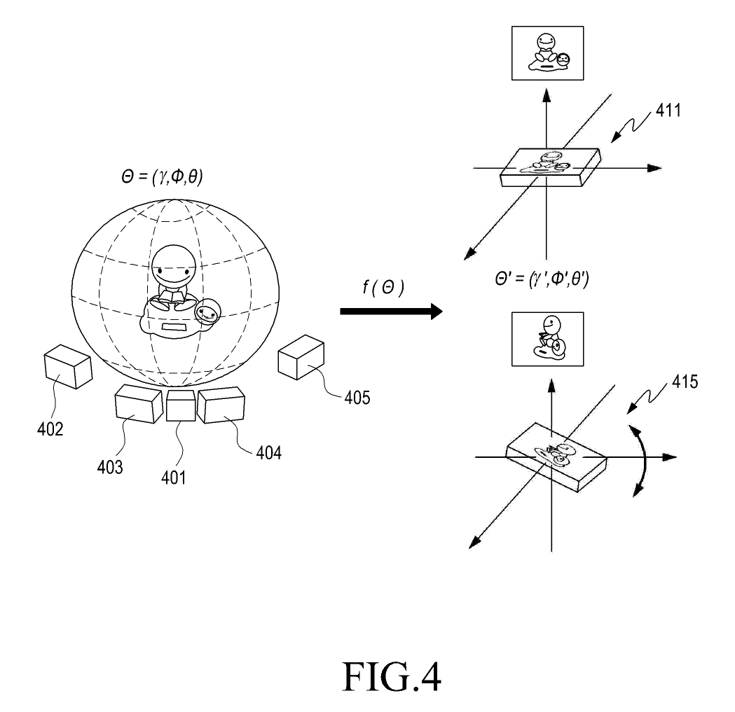

FIG. 4 illustrates location information corrected by an image data processing device according to the present invention.

In FIG. 4, as a request signal for capturing images is received from a first location 401 through the key input unit 101, the controller 104 enables the camera 111, which captures an initial image and provides it to the controller 104 for storing the initial image in the memory 103 as first image information. In addition, the controller 104 instructs an operation of the location information checker 113, and requests location information at the time the initial image was captured. The location information checker 113 detects location information (Θ=(γ, φ, θ)) of the mobile terminal, and provides the detected location information to the controller 104. Accordingly, the controller 104 links the location information, as shooting reference location information (Θ₁=(γ₁, φ₁, θ₁)), to the first image information, and stores the linked information in the memory 103. In addition, as request signals for continuously capturing images are received from second, third, fourth and fifth locations 402, 403, 404 and 405 through the key input unit 101, the controller 104 enables the camera 111 to capture images in the respective locations, and stores the images in the memory 103 as second, third, fourth and fifth image information, respectively. The controller 104 determines location information corresponding to the second, third, fourth and fifth image information by means of the location information checker 113, and stores the determined location information in the memory 103 as second, third, fourth and fifth shooting location information (Θ₂=(γ₂, φ₂, θ₂), Θ₃=(γ₃, φ₃, θ₃), Θ₄=(γ₄, φ₄, θ₄), Θ₅=(γ₅, φ₅, θ₅)), respectively. These images captured for the same object may be managed as one image group, and at least one shooting reference location information may be set in each image group.

When the user selects, with the key input unit 101, a function (i.e., a location information-based photo viewer function) in which the user can check the images, which were captured by the camera 111 according to the motion of the mobile terminal, at various different angles, the controller 104 provides at least one image group stored in the memory 103 to the user, and receives from the user an input to select an image group to be displayed. In response to the input, the controller 104 enables the location information converter 115, which receives initial location information (i.e., display reference location information (Θ′=(γ′, φ′, θ′)) from the location information checker 113. The controller 104 checks the shooting reference location information of the image group from the memory 103, and provides it to the location information converter 115.

The location information converter 115 converts the shooting reference location information indicated by first coordinates 411 into the display reference location information indicated by second coordinates 415. Based on the conversion values of the shooting reference location information, the location information converter 115 converts the shooting reference location information and shooting location information of images included in the same image group, and stores the converted shooting location information in the memory 103.

While the location information-based photo viewer function is run, the controller 104 requests location information from the location information checker 113 at time intervals, such as every 1/10 seconds. The controller 104 detects image information corresponding to the location information from the memory 103, and outputs or displays the detected image information on the display 102.

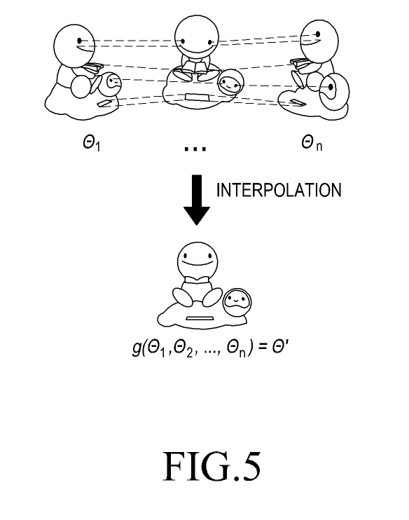

When images included in an image group are captured, the shooting interval may not be uniform or the images may not be continuously stored. Accordingly, image information corresponding to the location information may not exist in the memory 103, and the images output on the display 102 may be artificially displayed. To solve these problems, the image data processing device may further include an image interpolator (not shown). For example, as shown in FIG. 5, the image interpolator may generate, by interpolation, the image information corresponding to the location information (Θ′=g(Θ₁, Θ₂, . . . Θₙ)) that is not stored in the memory 103 during image capturing, using the image information included in the image group and having different location information (Θ₁, . . . Θₙ), and may store the generated images in the memory 103 or may output the generated images on the display 102.

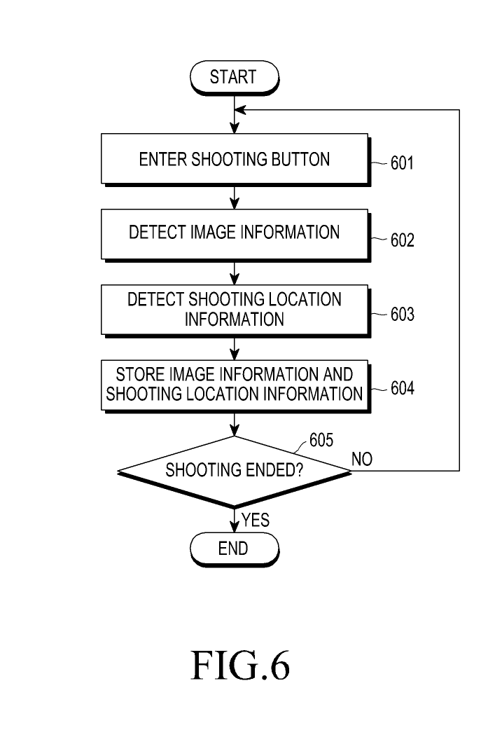

FIG. 6 illustrates a process of capturing images based on location information in an image data processing method according to the present invention.

The mobile terminal provides a menu for activating its camera function. When this menu is selected by the user, the mobile terminal provides a user interface on which a camera's shooting mode is selected. Specifically, the mobile terminal provides an interface on which the user selects any one of a video mode and a photo mode of the camera. In addition, the mobile terminal provides, as a sub menu of the photo mode, a menu in which the user selects or determines whether to activate a location information-based photo-taking function. As the user selects a photo-taking function based on location information using the user interface provided by the mobile terminal, the mobile terminal activates the photo-taking function based on the location information, and receives an input of a shooting button (or shutter button) from the user in step 601.

Before receiving the input of the shooting button from the user in step 601, the mobile terminal may provide an interface on which when using the location information-based photo-taking function, the user can select or determine whether to set the function to the central shooting mode for taking photos of the object 301 centering on the user as shown in FIG. 3A, or set the function to the surrounding shooting mode for taking photos centering on the object 305 as shown in FIG. 3B. The mode selected by the user may be stored in the memory 103.

In response to the input of the shooting button from the user, the mobile terminal generates image information by detecting and processing color information of a target object using an image sensor such as a CCD and a CMOS, in step 602.

Upon generation of the image information, the mobile terminal activates sensors, such as for detecting information about a shooting direction, shooting angle, angular speed and acceleration, for detecting location information, and detects shooting location information (Θ=(γ, φ, θ)) at the time the image information were acquired, in step 603.

The mobile terminal links the image information to the shooting location information, and stores the linked information in the memory 103, in step 604. As for the image information, multiple images may be set as one image group and stored in the memory 103. The image group includes image information of images serving as a reference for image capturing, and shooting location information corresponding to the image information of images serving as a reference is stored as shooting reference location information.

In step 605, the mobile station determines whether the shooting has ended. If the shooting has ended, the mobile terminal ends the location information-based photo-taking function. If the shooting has not ended, the mobile terminal repeats steps 601 to 604 in sequence to detect and store the image information and the shooting location information.

In the present invention, the input of the shooting button in step 601 may be performed using a button, such as a shutter button of a camera, prepared for a user to capture images. Alternatively, the input of the shooting button may be a signal that is automatically generated by setting of the mobile terminal. For example, the input of the shooting button may be a shooting signal that the mobile terminal repeatedly generates at time intervals, such as per second, until the user inputs a button for instructing end of the shooting after selecting a menu for activating the location information-based photo-taking function and inputs a button for starting shooting.

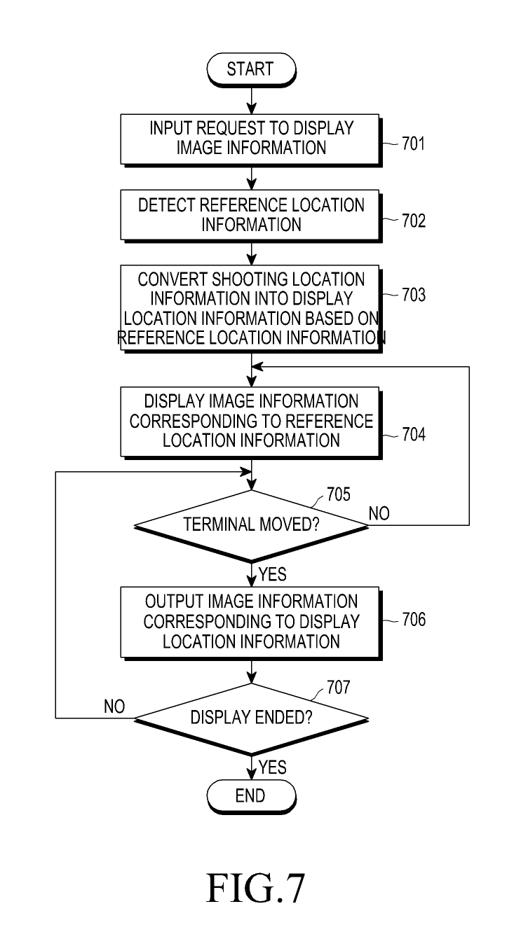

FIG. 7 illustrates a process of checking photos taken based on location information in an image data processing method according to the present invention.

The mobile terminal provides a menu for activating a photo-viewer function for displaying photos stored in its memory. In particular, the mobile terminal provides a menu capable of activating a location information-based photo-viewer function for viewing photos previously taken based on location information, and currently based on the location information of the mobile terminal. Accordingly, in step 701, as the user selects the photo-viewer function, a request signal for displaying photos stored in the memory is input to the mobile terminal. Furthermore, in step 701, the mobile terminal provides a list of image groups stored in the memory, as images corresponding to the photos taken based on the location information. One of the image groups is selected by the user.

In step 702, the mobile terminal activates sensors for detecting location information, and detects initial location information (i.e., display reference location information Θ′=(γ′, φ′, θ′) of the mobile terminal.

In step 703, the mobile terminal checks data stored in the memory, and checks shooting reference location information of the selected image group. The mobile terminal converts the shooting reference location information into the display reference location information. Based on the conversion values of the shooting reference location information, the mobile terminal converts the shooting reference location information and shooting location information of images included in the same image group, and stores the converted shooting location information in the memory.

Specifically, in step 703, the mobile terminal detects a location coordinate set by checking location coordinates at the time at least one image included in the selected image group was captured. The mobile terminal normalizes the detected location coordinate set. For example, at least one image included in the image group may be indicated as I₁, I₂, . . . Iₙ, and the image group may be indicated as (I₁, I₂, . . . Iₙ). The location coordinate set of the image group may be defined as Equation (1). The normalized location coordinate set can be defined as Equation (2). The mobile terminal calculates reference values to represent resolutions in the left and right directions centered on the median value in the normalized location coordinate set, in accordance with Equation (3). Through this computation, the mobile terminal converts the location coordinates (a, b) shown in FIG. 2A into location coordinates (−c, c) shown in FIG. 2B.

In step 704, the mobile terminal detects image information corresponding to the display reference location information, and outputs the detected image information on its display. The mobile terminal displays an image existing in the middle location, among the coordinate-converted images.

The location the user checks the images using the location information-based photo-viewer function may be different from the location the images were captured. Accordingly, the mobile terminal may receive information about an interval of the location the user checks images, by further providing a menu by which the user may set an interval of the location the images are checked. The mobile terminal may convert the converted location coordinates (−c, c) into coordinates (−b, b) and reset a difference in location between adjacent images to b/(n+1) as shown in FIG. 2C.

In step 705, the mobile terminal determines whether it has moved by comparing detected values of the sensors for detecting location information, with values of the display reference location information. If it is determined that the mobile terminal has not moved in step 705, the mobile terminal returns to step 704. Otherwise, if it is determined that the mobile terminal has moved, the mobile terminal proceeds to step 706.

In step 706, the mobile terminal checks display location information from the values detected by the sensors for detecting location information, detects image information corresponding to the display location information from the memory, and outputs the detected image information on the display. The location information of the mobile terminal may be obtained by checking relative coordinates of the reference location information.

In step 707, the mobile terminal determines whether the location information-based photo-viewer function of the mobile terminal has ended. Upon receiving a request signal for ending the photo-location information-based photo-viewer function of the mobile terminal in step 707, the mobile terminal ends the location information-based photo-viewer function. If the location information-based photo-viewer function has not ended, the mobile terminal returns to step 705 and repeats the succeeding steps.

When images included in an image group are captured, the shooting interval may not be uniform or the images may not be continuously stored. Accordingly, image information corresponding to the display location information may not exist in the memory, and the images output on the display may be artificially displayed. To solve these problems, the image data processing method may further include a process of generating image information corresponding to the display location information by interpolation.

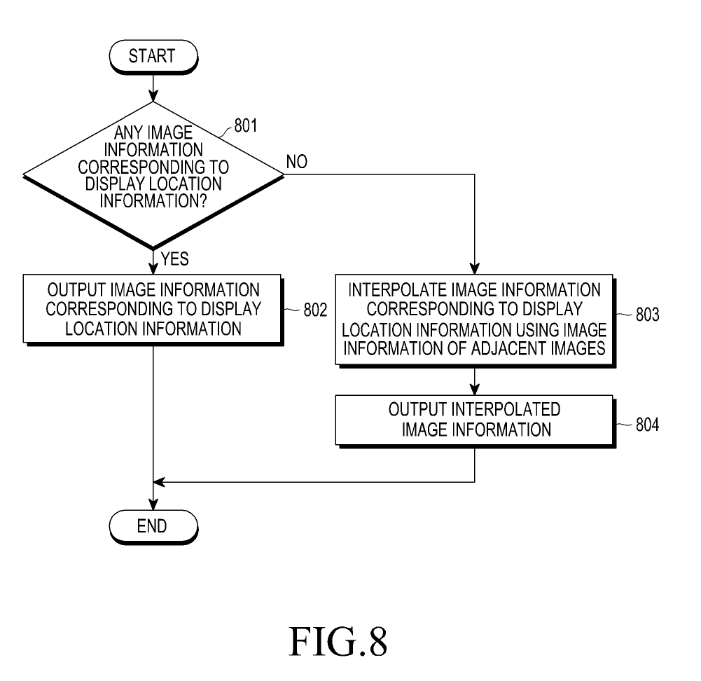

FIG. 8 illustrates a detailed process of step 706 of outputting image information corresponding to the display location information in FIG. 7.

In step 801, the mobile terminal checks the display location information, and determines whether image information corresponding to the display location information exists in the memory. If the image information corresponding to the display location information exists in the memory, the mobile terminal detects the image information corresponding to the display location information from the memory and outputs the detected image information on the display in step 802. If the image information corresponding to the display location information does not exist in the memory, the mobile terminal detects image information of adjacent images based on the display location information in step 803. The mobile terminal generates image information corresponding to the display location information by interpolation, based on the image information of adjacent images. In step 804, the mobile terminal outputs the image information generated by interpolation on the display.

As is apparent from the foregoing description, the disclosed image data processing apparatus and method provides image information that is stored based on information about a shooting direction, shooting angle, angular speed and acceleration of the terminal, and in particular, displays images in various manners depending on the information about the shooting direction, shooting angle, angular speed and acceleration of the terminal of the user viewing the images, allowing the user to fully enjoy 3D spatial information. Even though location and trajectory information of the captured actual images is unknown, the terminal may recognize the current location of the terminal of the user and convert coordinates of the images to correspond to the user's terminal, enabling the user to conveniently enjoy the images. In addition, the disclosed image data processing apparatus and method saves storage space by image interpolation, and allowing the user to enjoy more natural images by viewing a smaller number of images.

Embodiments of the present invention can also be embodied as computer-readable codes on a computer-readable recording medium. The computer-readable recording medium is any data storage device that can store data and can thereafter be read by a computer system. Examples of the computer-readable recording medium include, but are not limited to, Read-Only Memory (ROM), Random-Access Memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the invention has been shown and described with reference to embodiments thereof, it will be understood by those skilled in the art that various changes in form and details may be made therein without departing from the spirit and scope of the invention as defined by the appended claims and their equivalents.

What is claimed is:

1. A method for processing image data of a device, comprising:
checking image information and shooting location information indicating location information at an acquisition time of the image information;
storing the image information and the shooting location information in the device;
checking display location information indicating location information of a terminal that will display the image information;
converting the shooting location information into the display location information by matching the shooting location information to the display location information; and
outputting image information corresponding to the display location information into which the shooting location information is converted.

2. The method of claim 1, wherein checking image information and shooting location information comprises checking shooting reference location information serving as a reference for image capturing;
wherein the checking of display location information comprises checking display reference location information serving as a reference for image displaying.

3. The method of claim 2, wherein converting the shooting location information into the display location information comprises:
converting the shooting reference location information based on the display reference location information; and
converting the shooting location information based on a change in the shooting reference location information.

4. The method of claim 1, wherein each of the shooting location information and the display location information comprises information about a shooting direction, a shooting angle, an angular speed and acceleration of the device.

5. The method of claim 1, wherein outputting image information comprises interpolating the image information in response to the absence of previously stored image information corresponding to the display location information.

6. The method of claim 1, wherein checking image information and shooting location information comprises:
checking image information about at least two images; and
checking shooting location information corresponding to the image information about at least two images.

7. An apparatus for processing image data, comprising:
a camera for detecting image information received through an image sensor;
a location information checker for checking location information;
a memory for storing the image information and shooting location information at an acquisition time of the image information;
a location information converter for converting the shooting location information based on display location information at a time the image information is to be displayed; and
a controller for controlling output of image information corresponding to the display location information.

8. The apparatus of claim 7, wherein the location information checker checks information about at least one of a shooting direction, a shooting angle, an angular speed and acceleration of the camera.

9. The apparatus of claim 7, wherein the controller stores location information serving as a reference for image shooting in the memory as shooting reference location information, and stores location information serving as a reference for displaying the image information in the memory as display reference location information.

10. The apparatus of claim 9, wherein the location information converter converts the shooting reference location information based on the display reference location information, and converts the shooting location information based on a change in the shooting reference location information.

11. The apparatus of claim 7, further comprising an image information interpolator for interpolating the image information based on image information of adjacent images, in response to the absence of previously stored image information corresponding to the display location information.

12. A computer-readable recording medium having recorded thereon a program for executing the method of processing image data of a device, the method comprising:
checking image information and shooting location information indicating location information at an acquisition time of the image information;
storing the image information and the shooting location information in the device;
checking display location information indicating location information of a terminal that will display the image information;
converting the shooting location information into the display location information by matching the shooting location information to the display location information; and
outputting image information corresponding to the display location information into which the shooting location information is converted
